(19) United States
(12) Patent Application Publication
(10) Pub. No.: US 2024/0336429 A1
(43) Pub. Date: Oct. 10, 2024

(54) PICKING STATION

(71) Applicant: Ocado Innovation Limited, Hatfield, Hertfordshire (GB)

(72) Inventors: Tom CLANCY, Hatfield, Hertfordshire (GB); Christopher Richard James BRETT, Hatfield, Hertfordshire (GB); Davide LORA, Hatfield, Hertfordshire (GB); David SOBEY, Hatfield, Hertfordshire (GB)

(73) Assignee: Ocado Innovation Limited, Hatfield, Hertfordshire (GB)

(21) Appl. No.: 18/578,775

(22) PCT Filed: Jul. 12, 2022
(86) PCT No.: PCT/EP2022/069511

§ 371 Date: Jan. 12, 2024

(30) Foreign Application Priority Data
Jul. 12, 2021 (GB) 2110019.3
Oct. 27, 2021 (GB) 2115426.5
Nov. 5, 2021 (GB) 2115916.5
Jan. 21, 2022 (GB) 2200770.2

(51) Int. Cl. B65G 1/04; B25J 19/02; B65G 61/00

(52) U.S. Cl. CPC B65G 1/0464; B25J 19/023; B65G 1/0478; B65G 61/00

(57) ABSTRACT

A robotic picking station is provided for use with a cubic automated storage and retrieval system. The picking station is configured to operate on the grid of the storage and retrieval system such that is received within a single grid cell of the storage and retrieval system. The picking station is mounted to the framework of the storage and retrieval system and includes one or more robotic arms. The picking station includes a support which extends below the grid of the storage system and is secured beneath the grid. The support may be connected to a floor of the storage system. The support may be connected to one or more framework elements.

### TECHNICAL FIELD

The present invention relates generally to the field of picking stations for use in warehouses and/or fulfilment centres and more specifically to an apparatus and method relating to a robotic picking station.

### BACKGROUND

Online retail businesses selling multiple product lines, such as online grocers and supermarkets, require systems that are able to store tens or even hundreds of thousands of different product lines. The use of single-product stacks in such cases can be impractical, since a very large floor area would be required to accommodate all of the stacks required. Furthermore, it can be desirable only to store small quantities of some items, such as perishables or infrequently-ordered goods, making single-product stacks an inefficient solution.

International patent application WO 98/049075A (Autostore), the contents of which are incorporated herein by reference, describes a system in which multi-product stacks of containers are arranged within a frame structure.

PCT Publication No. WO2015/185628A (Ocado) describes a further known storage and fulfilment system in which stacks of bins or containers are arranged within a framework structure. The bins or containers are accessed by load handling devices operative on tracks located on the top of the frame structure. The load handling devices lift bins or containers out from the stacks, multiple load handling devices co-operating to access bins or containers located in the lowest positions of the stack. A system of this type is illustrated schematically in FIGS. 1 to 4 of the accompanying drawings.

FIG. 1 illustrates an automated storage and retrieval structure 1 comprising upright members 3 and horizontal members 5, 7 which are supported by the upright members 3. The horizontal members 5 extend parallel to one another and the illustrated x-axis. The horizontal members 7 extend parallel to one another and the illustrated y-axis, and transversely to the horizontal members 5. The upright members 3 extend parallel to one another and the illustrated z-axis, and transversely to the horizontal members 5, 7. The horizontal members 5, 7 form a grid pattern defining a plurality of grid cells. In the illustrated example, containers 9 are arranged in stacks 11 beneath the grid cells defined by the grid pattern, one stack 11 of containers 9 per grid cell.

FIG. 2 shows a large-scale plan view of a section of track structure 13 forming part of the storage structure 1 illustrated in FIG. 1 and located on top of the horizontal members 5, 7 of the storage structure 1 illustrated in FIG. 1. The track structure 13 may be provided by the horizontal members 5, 7 themselves (e.g. formed in or on the surfaces of the horizontal members 5, 7) or by one or more additional components mounted on top of the horizontal members 5, 7. The illustrated track structure 13 comprises x-direction tracks 17 and y-direction tracks 19, i.e. a first set of tracks 17 which extend in the x-direction and a second set of tracks 19 which extend in the y-direction, transverse to the tracks 17 in the first set of tracks 17. The tracks 17, 19 define apertures 15 at the centres of the grid cells. The apertures 15 are sized to allow containers 9 located beneath the grid cells to be lifted and lowered through the apertures 15. The x-direction tracks 17 are provided in pairs separated by channels 21, and the y-direction tracks 19 are provided in pairs separated by channels 23. Other arrangements of track structure may also be possible.

FIG. 3 shows a plurality of load-handling devices 31 moving on top of the storage structure 1 illustrated in FIG. 1. The load-handling devices 31, which may also be referred to as robots 31 or bots 31, are provided with sets of wheels to engage with corresponding x- or y-direction tracks 17, 19 to enable the bots 31 to travel across the track structure 13 and reach specific grid cells. The illustrated pairs of tracks 17, 19 separated by channels 21, 23 allow bots 31 to occupy (or pass one another on) neighbouring grid cells without colliding with one another.

As illustrated in detail in FIG. 4, a bot 31 comprises a body 33 in or on which are mounted one or more components which enable the bot 31 to perform its intended functions. These functions may include moving across the storage structure 1 on the track structure 13 and raising or lowering containers 9 (e.g. from or to stacks 11) so that the bot 31 can retrieve or deposit containers 9 in specific locations defined by the grid pattern.

The illustrated bot 31 comprises first and second sets of wheels 35, 37 which are mounted on the body 33 of the bot 31 and enable the bot 31 to move in the x- and y-directions along the tracks 17 and 19, respectively. In particular, two wheels 35 are provided on the shorter side of the bot 31 visible FIG. 4, and a further two wheels 35 are provided on the opposite shorter side of the bot 31 (side and further two wheels 35 not visible in FIG. 4). The wheels 35 engage with tracks 17 and are rotatably mounted on the body 33 of the bot 31 to allow the bot 31 to move along the tracks 17. Analogously, two wheels 37 are provided on the longer side of the bot 31 visible in FIG. 4, and a further two wheels 37 are provided on the opposite longer side of the bot 31 (side and further two wheels 37 not visible in FIG. 4). The wheels 37 engage with tracks 19 and are rotatably mounted on the body 33 of the bot 31 to allow the bot 31 to move along the tracks 19.

The bot 31 also comprises container-lifting means 39 configured to raise and lower containers 9. The illustrated container-lifting means 39 comprises four tapes or reels 41 which are connected at their lower ends to a container-engaging assembly 43. The container-engaging assembly 43 comprises engaging means (which may, for example, be provided at the corners of the assembly 43, in the vicinity of the tapes 41) configured to engage with features of the containers 9. For instance, the containers 9 may be provided with one or more apertures in their upper sides with which the engaging means can engage. Alternatively or additionally, the engaging means may be configured to hook under the rims or lips of the containers 9, and/or to clamp or grasp the containers 9. The tapes 41 may be wound up or down to raise or lower the container-engaging assembly, as required. One or more motors or other means may be provided to effect or control the winding up or down of the tapes 41.

As can be seen in FIG. 5, the body 33 of the illustrated bot 31 has an upper portion 45 and a lower portion 47. The upper portion 45 is configured to house one or more operation components (not shown). The lower portion 47 is arranged beneath the upper portion 45. The lower portion 47 comprises a container-receiving space or cavity for accommodating at least part of a container 9 that has been raised by the container-lifting means 39. The container-receiving space is sized such that enough of a container 9 can fit inside the cavity to enable the bot 31 to move across the track structure 13 on top of storage structure 1 without the underside of the container 9 catching on the track structure 13 or another part of the storage structure 1. When the bot 31 has reached its intended destination, the container-lifting means 39 controls the tapes 41 to lower the container-gripping assembly 43 and the corresponding container 9 out of the cavity in the lower portion 47 and into the intended position. The intended position may be a stack 11 of containers 9 or an egress point of the storage structure 1 (or an ingress point of the storage structure 1 if the bot 31 has moved to collect a container 9 for storage in the storage structure 1). Although in the illustrated example the upper and lower portions 45, 47 are separated by a physical divider, in other embodiments, the upper and lower portions 45, 47 may not be physically divided by a specific component or part of the body 33 of the bot 31.

In some embodiments, the container-receiving space of the bot 31 may not be within the body 33 of the bot 31. For example, in some embodiments, the container-receiving space may be adjacent to the body 33 of the bot 31, e.g. in a cantilever arrangement with the weight of the body 33 of the bot 31 counterbalancing the weight of the container to be lifted. In such embodiments, a frame or arms of the container-lifting means 39 may protrude horizontally from the body 33 of the bot 31, and the tapes/reels 41 may be arranged at respective locations on the protruding frame/arms and configured to be raised and lowered from those locations to raise and lower a container into the container-receiving space adjacent to the body 33. The height at which the frame/arms is/are mounted on and protrude(s) from the body 33 of the bot 31 may be chosen to provide a desired effect. For example, it may be preferable for the frame/arms to protrude at a high level on the body 33 of the bot 31 to allow a larger container (or a plurality of containers) to be raised into the container-receiving space beneath the frame/arms. Alternatively, the frame/arms may be arranged to protrude lower down the body 33 (but still high enough to accommodate at least one container between the frame/arms and the track structure 13) to keep the centre of mass of the bot 31 lower when the bot 31 is loaded with a container.

To enable the bot 31 to move on the different wheels 35, 37 in the first and second directions, the bot 31 includes a wheel-positioning mechanism for selectively engaging either the first set of wheels 35 with the first set of tracks 17 or the second set of wheels 37 with the second set of tracks 19. The wheel-positioning mechanism is configured to raise and lower the first set of wheels 35 and/or the second set of wheels 37 relative to the body 33, thereby enabling the load-handling device 31 to selectively move in either the first direction or the second direction across the tracks 17, 19 of the storage structure 1.

The wheel-positioning mechanism may include one or more linear actuators, rotary components or other means for raising and lowering at least one set of wheels 35, 37 relative to the body 33 of the bot 31 to bring the at least one set of wheels 35, 37 out of and into contact with the tracks 17, 19. In some examples, only one set of wheels is configured to be raised and lowered, and the act of lowering the one set of wheels may effectively lift the other set of wheels clear of the corresponding tracks while the act of raising the one set of wheels may effectively lower the other set of wheels into contact with the corresponding tracks. In other examples, both sets of wheels may be raised and lowered, advantageously meaning that the body 33 of the bot 31 stays substantially at the same height and therefore the weight of the body 33 and the components mounted thereon does not need to be lifted and lowered by The system described with reference to FIGS. 1 to 4 has many advantages and is suitable for a wide range of storage and retrieval operations. In particular, it allows very dense storage of product, and it provides a very economical way of storing a huge range of different items in the containers 9, while allowing reasonably economical access to all of the containers when required for picking.

As shown in FIG. 3, a plurality of identical load handling devices 31 are provided, so that each load handling device 31 can operate simultaneously to increase the throughput of the system. The system illustrated in FIG. 3 may include specific locations, known as ports, at which containers can be transferred into or out of the system. An additional conveyor system (not shown) is associated with each port, so that containers transported to a port by a load handling device 31 can be transferred to another location by the conveyor system, for example to a picking station (not shown). Similarly, containers can be moved by the conveyor system to a port from an external location, for example to a container-filling station (not shown), and transported to a stack 12 by the load handling devices 30 to replenish the stock in the system.

Each load handling device 31 can lift and move one containers at a time. If it is necessary to retrieve a container (“target container”) that is not located on the top of a stack, then the overlying containers (“non-target containers”) must first be moved to allow access to the target containers. This is achieved in an operation referred to hereafter as “digging”. During a digging operation, one of the load handling devices sequentially lifts each non-target container from the stack containing the target container and places it in a vacant position within another stack. The target container can then be accessed by the load handling device and moved to a port for further transportation.

Each of the load handling devices is under the control of a central computer. Each individual container in the system is tracked, so that the appropriate containers can be retrieved, transported and replaced as necessary. For example, during a digging operation, the locations of each of the non-target containers is logged, so that the non-target containers can be tracked.

The system described with reference to FIGS. 1 to 5 has many advantages and is suitable for a wide range of storage and retrieval operations. In particular, it allows very dense storage of product, and it provides a very economical way of storing a huge range of different items in the containers, while allowing reasonably economical access to all of the containers when required for picking.

### SUMMARY

In general terms, the invention introduces a robotic picking station which can be operated on the surface of a grid-based automated storage and retrieval system.

According to a first aspect of the present invention there is provided a picking station for use in a grid-based storage system, the picking station comprising: a robotic arm; and a mount for mounting the robotic arm to one or more framework members of the storage system, such that the robotic arm is configured to be received within a single grid cell of the storage system; wherein, in use, i) the eight grid cells surrounding the picking station are reserved for use by the picking station; ii) the eight grid cells are divided into a first zone and a second zone such that each of the zones comprise one or more grid cells for receiving a delivery container and one or more grid cells for receiving a respective storage container

The mount may further comprise a support member which extends below the surface of the grid. The support member may be connected to one or more framework members of the storage system. The support member may be connected to one or more vertical members of the storage system and/or it may be connected to one or more horizontal members of the storage system. The support member may be connected a floor of the storage system.

The mount may be directly connected to one or more vertical members of the storage system. The mount may be directly connected to one or more horizontal members of the storage system. The mount may comprise a plinth, the plinth being configured to be connected to one or more framework members of the storage system and to be received within a grid cell of the storage system. The plinth may extend across substantially all of the grid cell within which the picking station is received.

The picking station may comprise a computing device, the computing device comprising one or more processing units, one or more volatile data storage units, one or more non-volatile data storage units and a network interface. Additionally, or alternatively, the picking station may communicably coupled to such a computing device. The computing device may comprise a controller apparatus which is configured, in use, to send signals to the picking station to control the operation of the robotic arm.

According to a second aspect of the present invention there is provided a storage system comprising: a first set of tracks extending in a first direction; a second set of tracks extending in a second direction transverse to the first direction, to form a grid comprising a plurality of grid cells, a framework structure on which the first set of tracks and the second set of tracks are received such that a stack of containers may be stored below each of the plurality of grid cells; and one or more picking stations as described above. The storage system may comprise a plurality of load-handling devices for lifting and moving containers stacked in stacks within the storage system, each of the load-handling devices being configured to move on the tracks above the stacks of containers.

The picking station may be configured, in use, to pick one or more items from the storage containers received in the first zone and to transfer them into the delivery container of the first zone. Furthermore, a plurality of load-handling devices may remove one or more storage containers from the second zone. A load-handling device may also remove the delivery container from the second zone. Subsequently, a plurality of load-handling devices may deposit one or more storage containers into grid locations in the second zone. A load-handling device may also deposit a delivery container into the second zone. The picking station may then pick one or more items from the storage containers received in the second zone and transfer the picked items into the delivery container of the second zone.

### BRIEF DESCRIPTION OF THE DRAWINGS

Embodiments of the invention will now be described by way of example only with reference to the accompanying drawings, in which like reference numbers designate the same or corresponding parts, and in which:

FIG. 1 shows a schematic depiction of an automated storage and retrieval structure;

FIG. 2 shows a schematic depiction of s plan view of a section of track structure forming part of the storage structure of FIG. 1;

FIG. 3 shows a schematic depiction of a plurality of load-handling devices moving on top of the storage structure of FIG. 1;

FIGS. 4 and 5 show a schematic depiction of a load handling device interacting with a container;

FIG. 6 shows a schematic depiction of a robotic picking station according to the present invention;

FIG. 7 shows a schematic depiction of a part of the storage system shown in FIG. 1

FIG. 8 shows a schematic depiction of a picking method according to the present invention;

FIG. 9 shows a schematic depiction of an overhead view of a storage which comprises one picking station according to the present invention;

FIG. 10 shows a schematic depiction of an overhead view of a storage system which comprises a plurality of picking stations according to the present invention;

FIG. 11 shows a schematic depiction of an overhead view of a storage system which comprises a plurality of picking stations according to a further example of the present invention;

FIG. 12 shows a schematic depiction of a picking station according to a further example of the present invention;

FIG. 13 shows a schematic depiction of a robotic arm similar to that described with reference to FIGS. 6 & 7;

FIG. 14 shows a schematic depiction of the connection of the robotic arm to the grid structure;

FIG. 15 shows a schematic depiction of a part of a storage system similar to that described with reference to FIG. 7;

FIG. 16 shows a schematic depiction of a part of a storage system similar to that described with reference to FIG. 15; and

FIG. 17 shows a schematic depiction of a computer device.

### DETAILED DESCRIPTION OF EMBODIMENTS

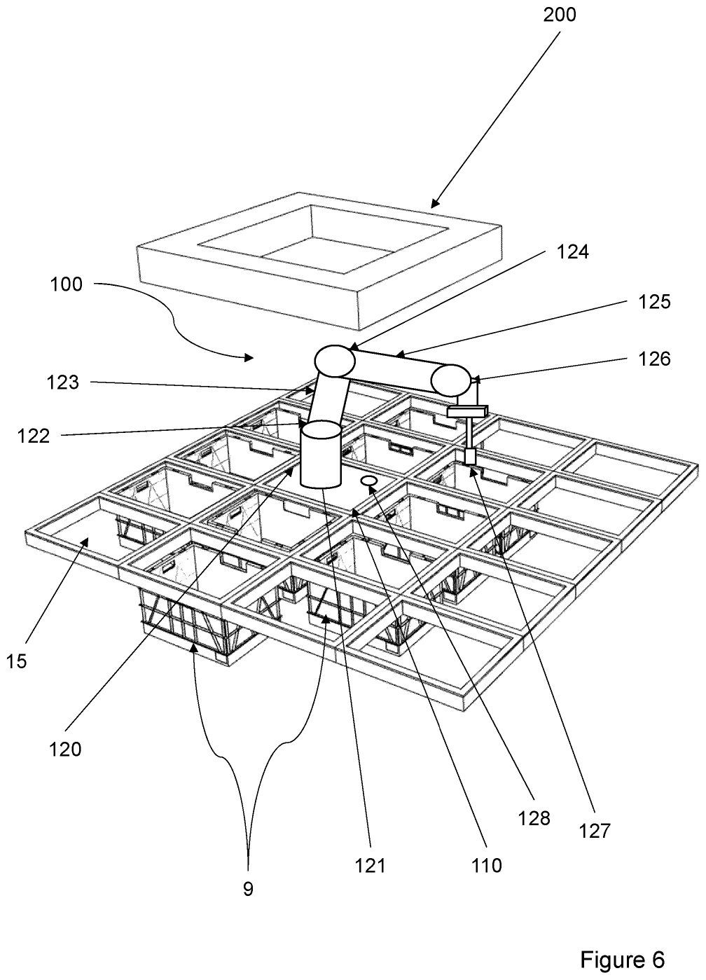

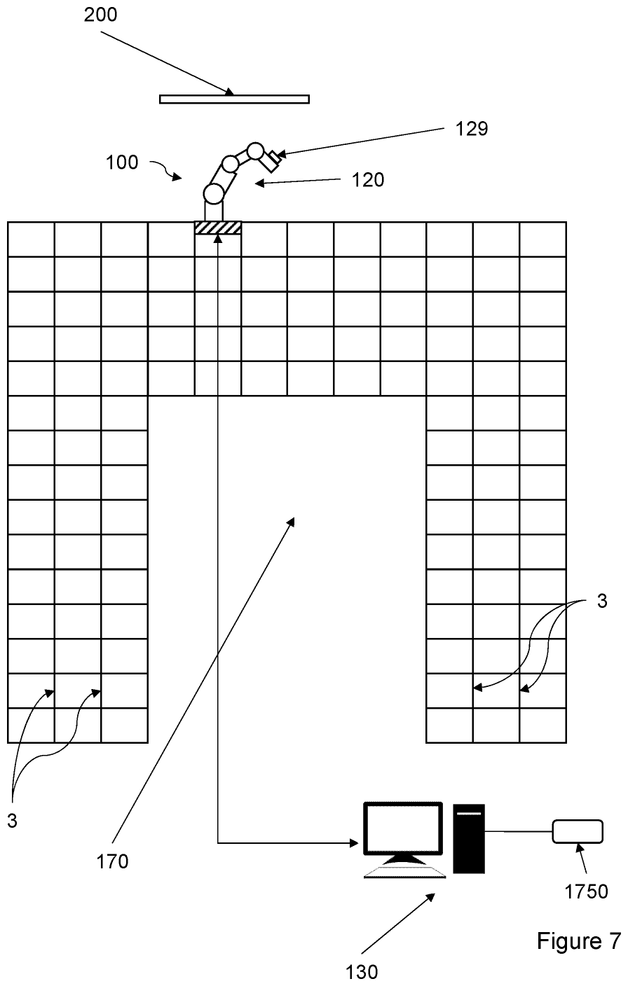

FIGS. 6 and 7 show a schematic depiction of a robotic picking station 100, which comprises a plinth 110 upon which a robotic arm 120 is received. The plinth 110 is of a size and shape such that it may be received within the aperture 15 of a grid cell formed by intersecting horizontal members 5, 7. The plinth may be substantially rectangular in shape. The plinth is connected to the framework of the storage system such that the robotic arm is mounted on the storage system. For example, the plinth may be connected to one or more of the upright members 3 of the storage system. Alternatively, the plinth may be connected to one or more of the horizontal members 5, 7 of the storage system. The plinth may be connected to one or more of the upright members 3 and one or more of the horizontal members 5, 7 of the storage system. The surface of the plinth may extend across substantially the entirety of the aperture of the grid cell in which it is received. This will reduce the risk that a dropped product may fall into the storage system, potentially interfering with the operation of the storage system. Alternatively, the surface of the plinth may only partially extend across the area of the grid cell in which it is received.

In an alternative, a mount may be used to connect the robotic arm to the framework of the grid structure. One or more mount members may mount the robotic arm, for example the base of the robotic arm, to one or more members of the storage system. The robotic arm may be mounted to: one or more upright members of the storage system; one or more horizontal members of the storage system; or one or more upright and one or more horizontal members of the storage system. The mount may be configurable such that the picking station may be retracted below the level of the grid (see below).

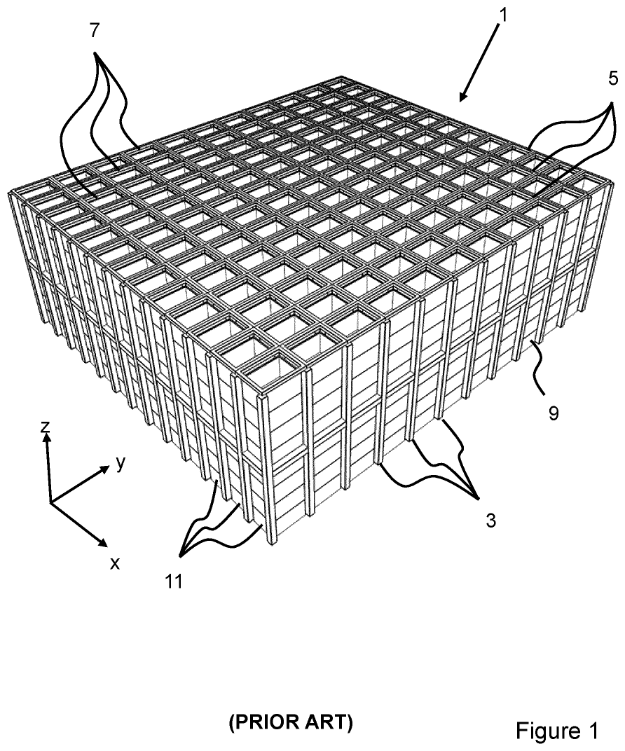

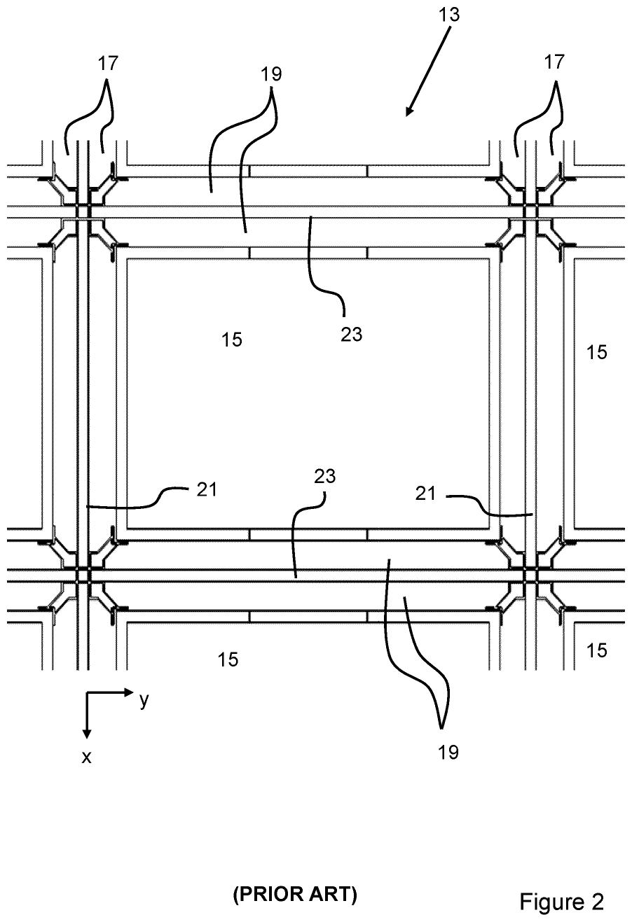

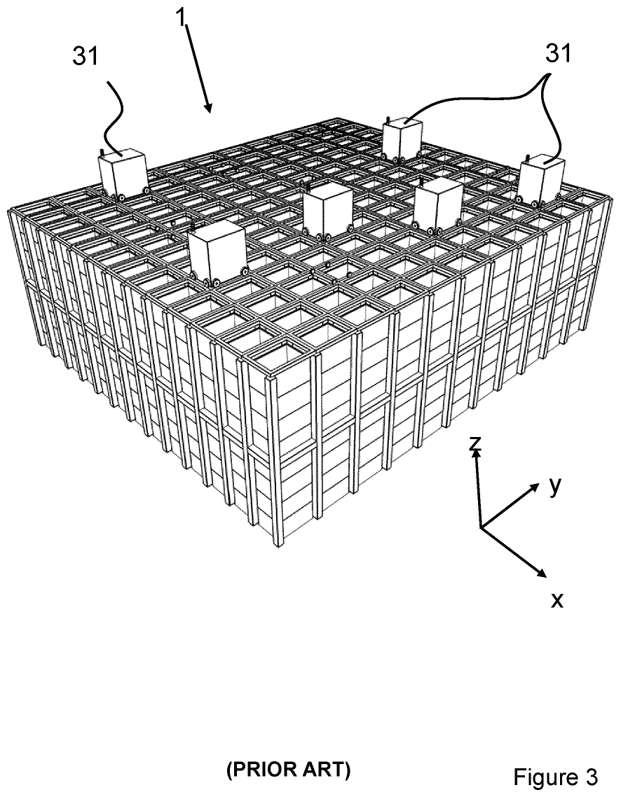

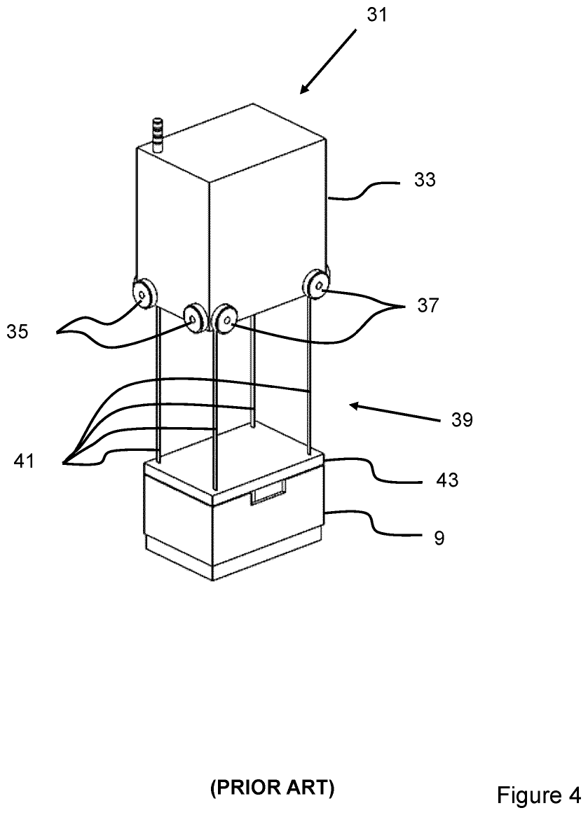

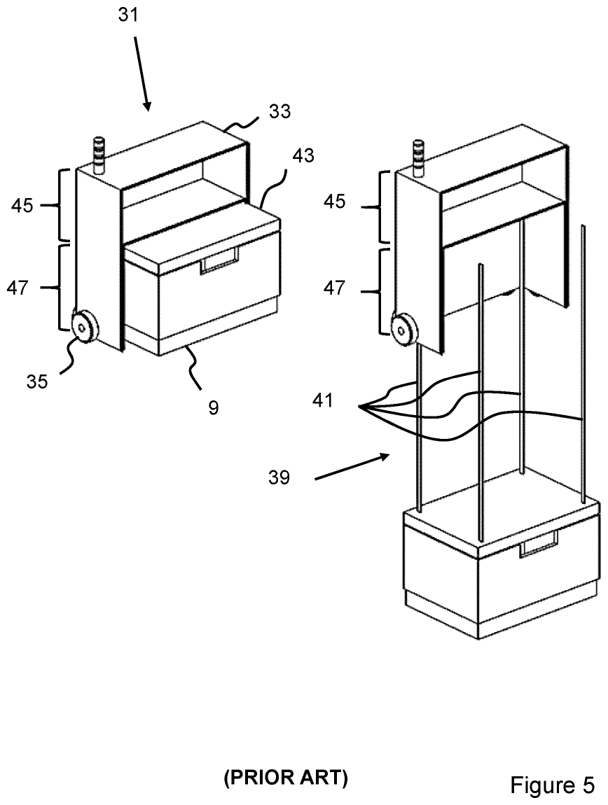

The robotic arm 120 comprises a base 121, first joint 122, upper arm portion 123, second joint 124, lower arm portion 125, third joint 126 and end effector 127. The base 121 extends substantially vertically from the plinth and is connected to the upper arm portion by the first joint, or shoulder. The upper arm portion is connected to the lower arm portion by the second joint, or elbow. The lower arm portion is connected to the end effector by the third joint, or wrist. The first joint, the second joint and the third joint may be selectively actuated such that the end effector may be moved along one or more of the x-axis, the y-axis and the z-axis (see FIG. 1). This means that the end effector may be moved into a first container such that it can be activated to engage with a product stored within that container. The product may then be lifted from the first container and the end effector may then be moved to a second container. Once the product is appropriately placed within the second container then the end effector may be deactivated such that the product is deposited into the second container. The end effector may comprise a suction device, a pair of opposed grippers, a plurality of fingers or other known effectors which can be used to grip and lift products. It should be understood that the specific configuration of the robotic arm shown in FIG. 6 is purely exemplary and that robotic arms of other configurations could be used. For example, the robotic arm may comprise a greater or lesser number of portions and joints.

The picking station may further comprise an optical sensor 128, which may be located on the upper surface of the plinth 120. The optical sensor may be used in the identification of products in the picking process. The picking station may comprise a plurality of optical sensors. In one example, the picking station may comprise four optical scanners, with one optical scanner being located at, or near to, each corner of the plinth. The or each optical scanner may comprise a barcode reader. In an alternative arrangement, one or more barcode scanners may be installed on the robotic arm, such that the barcode scanner(s) move with the arm. In a specific implementation, two barcode scanners may be installed onto the arm.

The picking station may further comprise a camera array 200, which is located above the plinth and arranged so as to be able to view the area in which the end effector will operate. FIG. 6 shows that the camera array 200 has a rectangular form but it should be understood that the camera array may take other forms, for example, square, elliptical circle, cruciform etc., or may comprise a plurality of discrete cameras. The camera array may further comprise lighting elements to illuminate the area in which the end effector will operate. The camera array may comprise one or more 3D cameras. The camera array may be suspended from the ceiling of the building which houses the storage system.

The picking station may further comprise one or more cameras mounted on the robotic arm. A camera 129 (see FIG. 7) may be mounted on, or near to, the end effector. A camera may be mounted on or near the wrist. In addition, or alternatively, a camera may be mounted on or near to the elbow of the robotic arm. The use of a camera, or cameras, mounted on the robotic arm may be in addition to the camera array 200 or as an alternative. The or each camera may be provided with lighting elements to illuminate the interior of a container when an item is being picked or deposited. One or more cameras may be located elsewhere on the picking station. For example, a camera may be used as a barcode scanner. If barcode scanner(s) are fitted to the arm then the lighting element of the barcode scanner(s) may be used to illuminate the interior of a container.

The picking station may further comprise a computer device 130, which may be used to control the movement of the robotic arm and the activation of the end effector. Images from the camera array may be fed to the computer device for processing to assist in the identification and/or grasping of items stored in containers. The computer device may be located beneath the plinth of the picking station. The picking station may, in an alternative (and as shown in FIG. 7), be connected to a remote computer device, for example by a wired Ethernet connection (or other network connection). Such a remote computer device may be used to control a plurality of picking stations. The remote computer device may be the central computer used to control the load handling devices. In a further alternative, a cloud computing platform may be used to control the picking stations within the storage system. A computer device may be located at or near to the camera array 200 such that images captured by the camera array can be processed and then transmitted to an associated picking station. A computer device located at or near to the camera array may perform a degree of image pre-processing with further image processing being performed at the picking station.

FIG. 6 shows a number of containers arranged near to the picking station, which provide a plurality of picking locations. In this example, the picking locations comprise the eight containers which are immediately adjacent to the picking station and two further containers. These two further containers are located in the middle space of the long edge of the array of the eight containers adjacent to the picking station. These ten containers are the containers that the end effector can reach, such that products can be picked from or to one of the containers. It should be understood that it is not sufficient that the end effector is able to reach the top of each of these containers but that the end effector is able to reach each of the lower corners of each of these containers, such that products may be picked from a container which is almost empty. It should be understood that the example shown in FIG. 6 is not limiting and that the exact number and siting of the picking locations may be varied and will be limited by the movement and range of the robotic arm. For example, a robotic arm with a greater reach (for example, a longer arm or an arm having a greater number of articulated portions) may increase the number of picking locations which are associated with a picking station.

A robotic arm may comprise more than one different type of end effector. The central computer may send instructions to the robotic arm as to which end effector to use for each different SKU. Alternatively, the robotic arm may determine which end effector to use based on the weight, size, shape etc. of a product. Previous successes and/or failures to grasp and move an item may be used to update the selection of an end effector for a particular SKU. This information may be fed back to the central computer so that the success/failure information can be shared between different picking stations. A robotic arm may be able to change end effectors. For example, the picking station may comprise a storage area which can receive one or more end effectors. Optionally, the storage area may be located within the plinth. The robotic arm may be configured such that an end effector in use can be removed from the robotic arm and placed into the end effector storage area. A further end effector may then be removably attached to the robotic arm such that it can be used for subsequent picking operations. The end effector may be selected in accordance with planned picking operations.

Alternatively, or in addition, a modified bot may be used to transport replacement end effectors. If a picking station has a need to change an end effector then the modified bot may be routed to the picking station such that the robotic arm can divest itself of an end effector in use and acquire a further end effector from the modified bot. Such an exchange may enable the robotic arm to better pick different types of products through the use of a different type of end effector but it may also allow a defective end effector to be replaced without the need to send a technician onto the grid, which would require that at least a part of the grid be closed down to enable a repair to be made safely.

The picking station described above with reference to FIGS. 6 & 7 comprises one robotic arm. It should be understood that a picking station may comprise two or more robotic arms. The picking station described above with reference to FIGS. 6 & 7 is shown as occupying one or more grid apertures. It should be understood that a picking station may comprise multiple adjacent grid apertures. Furthermore, an array of picking stations, each of which occupies a single grid aperture, may be provided in adjacent grid locations.

When a robotic arm is not required for picking operations, for example when the storage facility is temporarily operating at a lower than normal level of utilisation, then the robotic arm may be moved into an idle state position, such that the arm is received entirely within the footprint of the picking station. In such a case, the arm may be substantially vertical, or may be otherwise arranged such that it does not extend beyond the footprint of the picking station. The identification of a picking station in an idle state may allow the picking locations associated with that picking station to be temporarily re-classified, so that bots can use those grid locations for movement and/or storage of storage containers. Alternatively, in an idle state the picking station may be retracted beneath the surface of the grid. The grid location of the picking station may then be temporarily re-classified, so that bots can use that grid location for movement. When it is identified that there is a need for a picking station to emerge from an idle state, then the grid location of the picking locations and/or the picking station may be re-classified appropriately prior to the re-activation of the picking station (and the emergence of the picking station above the grid, if appropriate).

The containers in the picking locations may be considered as being storage containers or delivery containers. A storage container is a container which remains within the storage system and holds eaches of products which can be transferred from the storage container to a delivery container. A delivery container is a container that is introduced into the storage system when empty and that has a number of different products loaded into it. Once the delivery container is full, for example the products loaded into the delivery container meet a volume limit, a weight limit or some other limitation, or all of a set of specified products have been loaded into the storage container, then the delivery container will be transferred from the storage system such that it can be loaded into a vehicle for delivery to a customer. A delivery container may comprise one or more bags or cartons into which products may be loaded. A delivery container may be substantially the same size as a storage container. Alternatively, a delivery container may be slightly smaller than a storage container such that a delivery container may be nested within a storage container.

FIG. 7 shows a schematic depiction of a part of the storage system shown in FIG. 1. Conventionally, the storage system may comprise a region where the stacks of the storage system are reduced in height, that is each of the stacks in the truncated region can accommodate fewer containers than the stacks in the rest of the storage system. A recess 170 is formed underneath the region of the storage system which comprises the truncated stacks. Conventionally, a picking aisle may be located within this recessed area, with lifting and other transfer mechanisms provided to bring storage containers down from the grid surface for picking at manual picking stations and to then return the storage containers to the grid once the picking is complete. Although FIG. 7 shows that the reduced height region of the stacks may comprise several layers of containers, it should be understood that the reduced height region may comprise a single layer of containers. The manual picking stations, and other associated equipment may be located on a mezzanine floor to make efficient use of space beneath the grid.

A picking station 100 according to an aspect of the present invention may be located on the grid such that it is above the recess 170. The plinth 110 of the picking station may be adapted to engage with the horizontal members 5, 7 which form the grid location 15 within which the picking station is located. Furthermore, or as an alternative, the picking station may be adapted to engage with the vertical members 3 of the stack over which the picking station is received. The picking station may be releasably coupled to the horizontal and/or the vertical members (depending on the nature of the connection of the picking station to the grid structure) such that it can be retracted below the level of the grid. Furthermore, the picking station may be retractable to the extent that it can be withdrawn into the recess, for example to allow for maintenance or repair activities. This avoids the need to send technicians onto the grid in order to perform maintenance or repair activities.

On-grid picking stations according to the present invention may be retro-fitted to existing storage systems such that they can operate in a hybrid manner, with picking being carried out on the grid and at picking stations located within the recess and/or elsewhere within the storage system. If sufficient picking stations according to the present invention are provided on the grid then it may be possible to remove some or all of the picking stations located beneath the grid structure. As these picking stations and the associated lifting and transfer mechanisms require much greater space than the space required to maintain and service the on-grid picking stations then it would be possible to reduce the size of the recess. This can be achieved by extending some of the truncated height stacks, for example to the floor level, such that the space available for storage containers can be increased.

Whilst it is possible for the robotic pick station to automatically pick items from a storage container and then transfer them to delivery container where, for example, the product may be packed into a bag held within the delivery container, there may be conditions under which the robotic arm is not able to grasp a product item effectively, for example because of the orientation of the item in the storage container relative to other product items. In such a case, a repeated failure to grasp an item may cause an alert to be raised such that an operator may remotely operate the robotic arm, over-riding the automatic operation of the robotic arm. A controller apparatus 1750 may be communicably connected to the computer device 130 such that control commands may be transmitted to the robotic arm, causing the robotic arm to respond accordingly. The controller apparatus 1750 may comprise the keyboard 1715 and mouse 1712 of the computer device 130. Alternatively, or in addition, the controller apparatus 1750 may comprise may comprise modified gaming controllers (or similar handheld devices) and/or virtual reality or augmented reality headsets or other devices or interfaces.

The teleoperation of the robotic arm may comprise the operator taking complete control of the robotic arm, such that the components of the robotic arm are rotated or moved so as to bring the end effector into an appropriate position relative to the product to be picked. Subsequently the end effector can be activated to grasp the product, which can then be transferred to a delivery container (or a bag or carton within a delivery container). In an alternative, the operator may use the controller apparatus to define a region of an item to be picked, for example a flat surface of a box when the end effector comprises a suction end effector. The defined region can then be used by the robotic picking arm as an input into an automatic picking attempt. If the automatic picking attempt is still not successful then the operator may fully operate the arm to pick the item, as described above. It should be understood that some form of machine learning technology may be used to enable the automatic operation of the robotic picking arm. In such a case, the data generated during teleoperation of the robotic arm by a remote operator may be used to refine the algorithms used in the automatic operation of the robotic picking arm.

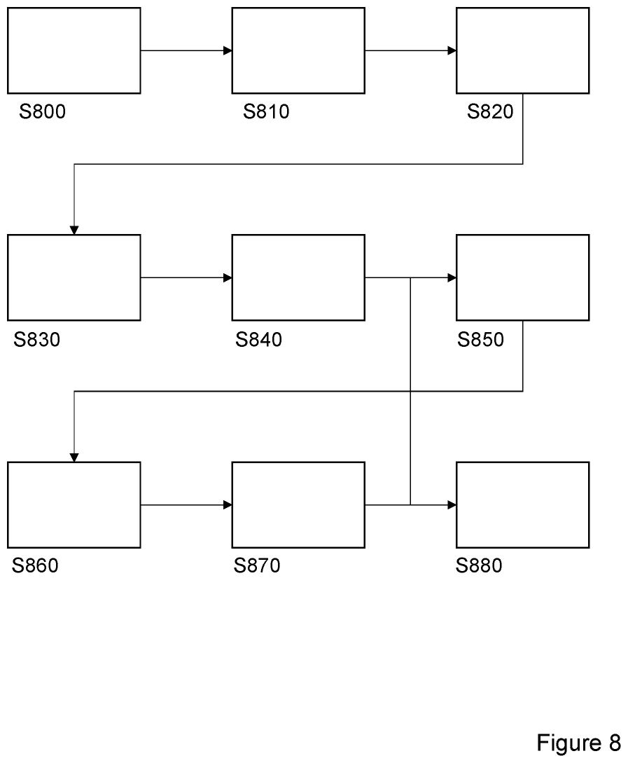

The process by which a customer order can be picked will now be described with reference to FIG. 8, which shows a schematic depiction of a picking method according to the present invention. At step 800, a customer order to be picked is accessed and processed. The central computer may comprise an ordering system which manages the delivery of customer orders and arranges for orders to be picked such that they may be sent out for delivery such that the order may be delivered to the customer in a pre-determined timeslot. At step S810 each of the products which comprise the customer order processed in S800 are identified and the respective storage container location for each product is determined. At step 820 each of the storage container locations are assigned to one or more bots. It will be understood that the number of bots required to efficiently pick a customer order will vary with the number of storage containers which must be retrieved to fulfil the customer order, the location of the storage containers relative to the picking station, etc. A bot may perform multiple storage container retrieval movements during the fulfilment of a customer order.

At step 830 the or each bot are assigned to a picking station. It should be understood that the storage system may comprise multiple zones, for example a refrigerated zone, a freezer zone, an ambient temperature zone etc., and that an order is likely to comprise products from more than one of these zones. Furthermore, each of the zones will comprise one or more picking stations as it will be necessary to pick, for example, refrigerated products at a picking station within the refrigerated zone of the storage system. The assignment of a bot to picking station may be made in accordance with the characteristics of the product to be picked and/or the picking station. For example, if a product is best suited to be picked by a suction end-effector then it will be assigned to a picking station which is operating with a suction end-effector (or which can be re-configured to operate with a suction end-effector by the time that the product has been delivered to the picking station).

At step S840, the or each bot is activated to move to the location of an assigned storage container such that the storage container can be retrieved. If a storage container is not at the top of a container stack then the digging process (see above) will be carried out to retrieve the storage container. The bot may autonomously determine its own route across the grid to the location of the assigned storage container or a route may be determined and then transmitted to the bot. The route may be determined by the central computer. A method by which a bot may determine its route across the grid is disclosed in the applicant's co-pending application WO2017/186825. A method by which communications to and from a bot may be performed is disclosed in the applicant's co-pending application WO2015/185726.

At step S850 the retrieved storage container is moved by the bot to one of the plurality of picking locations of the picking station to which the bot has been assigned. The identity of the picking location to be used may be determined and communicated to the bot. The bot will then deposit the retrieved storage container in the picking location to be used and moves to a further grid location. At step S860 the picking process is performed, such that one or more eaches of the product held in a storage container are moved to a delivery container. The storage container may be received within a picking location which is adjacent to the picking location of the delivery container. One or more eaches of a product may be picked from a storage container to two or more delivery containers. The two or more delivery containers may be associated with different customer orders. Once the picking from the storage container is complete then at step S870 a bot moves to the picking location of that storage container and retrieves the storage container from the picking location within the grid. At step S880 the bot moves the storage container to a further grid location and deposits the storage container within the grid. Alternatively, the process may return to step S850, wherein the bot moves to a further picking location such that the retrieved storage container may be deposited within that further picking location.

It should be understood that a storage container may be returned to the grid location from which it was retrieved in step S840 but alternatively it may be deposited at another grid location. If the product held in a storage container will be required in a relatively short period of time then the storage container may be deposited in a grid location which is relatively close to the pick station to reduce the time required to retrieve the storage container for a subsequent picking action. The bot which deposits a storage container in step S850 may wait for the end of the picking process to retrieve the storage container at step S870. Alternatively, the bot may be allocated to a different task, for example retrieving a further storage container for which the picking process is complete, such that there is more efficient utilisation of the bot. In such a case, a further bot will be allocated to retrieve the storage container once the picking process has been completed.

It should be understood that the order some of the steps of the method described above with reference to FIG. 8 may be varied without effecting the performance of the picking station. For example, the allocation of a bot, a storage container to be retrieved and a picking station may occur in one step. In a further example, a bot may be assigned to a pick station (S830) once a bot has retrieved an identified storage container (S840). Furthermore, one or more bots may be assigned to a particular pick station and are subsequently assigned storage containers to retrieve and to bring to the assigned pick station such that the products may be picked from the storage containers.

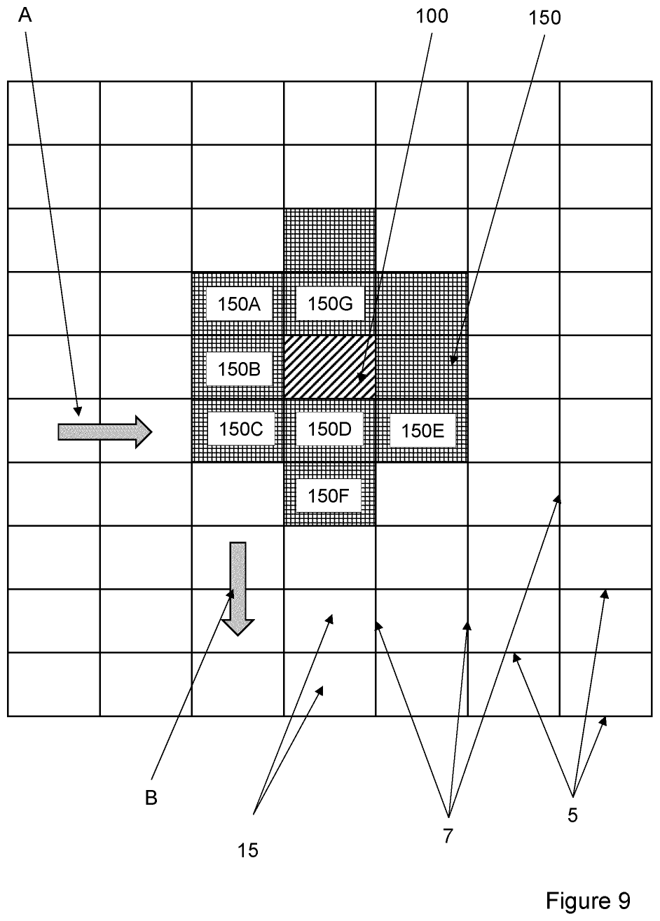

FIG. 9 shows a schematic depiction of an overhead view of the storage system of FIG. 1 which comprises one picking station according to the present invention. FIG. 9 shows the picking station 9 surrounded by a plurality of picking locations 150. In an exemplary method, a first bot may deposit a first delivery container in picking location 150B. This enables further bots to deposit storage containers in picking locations 150A and 150C. For example, as the picking station is transferring a product from a first storage container in picking location 150A into the delivery container, one bot may be retrieving a second storage container from picking location 150C such that a further bot can deposit a third storage container into picking location 150C. Once the picking from the first storage container is complete then the picking station may pick one or more items from the third storage container received in picking location 150C. Whilst the picking station is picking product from the third storage container then a bot may retrieve the first storage container from picking location 150A such that a yet further bot may deposit a fourth storage container into picking location 150A.

In a further exemplary method, delivery containers may be deposited into delivery locations 150B and 150D. Picking locations 150A & 150G may be used for storage containers that are to be used when picking into the delivery container held in picking location 150B. Picking locations 15E0E & 150F may be used for storage containers that are to be used when picking into the delivery container held in picking location 150D. Picking location 150C may be used for storage containers that can be used when picking into either the delivery container held in picking location 150B or the delivery container held in picking location 150D. It can be seen that it is advantageous to control the location of the delivery containers and the storage containers such that a delivery container is adjacent a storage container. This reduces the distance that a product needs to be moved during the picking process, reducing the time required to pick each product.

FIG. 9 also shows two arrows, which provide a schematic depiction of an example of the movement of a bot when depositing or retrieving a container. In this example, the bot approaches picking location 150C in a first direction along the grid (as shown by arrow A). Once the container has been deposited (or retrieved) then the bot leaves picking location 150C in the second direction along the grid (as shown by arrow B), that is in a direction that is perpendicular to the first direction. Such an arrangement reduces the risk that a bot leaving the picking station interferes with a further bot approaching the picking station.

It should be understood that the grid cells which are not occupied by a robotic picking station or are not designated as picking locations 150 may be regarded as storage locations, in that they are reserved for holding storage containers which contain product to be picked, or delivery containers which have been picked and are being stored temporarily before an order comprising one or more delivery containers is routed for loading into a delivery vehicle.

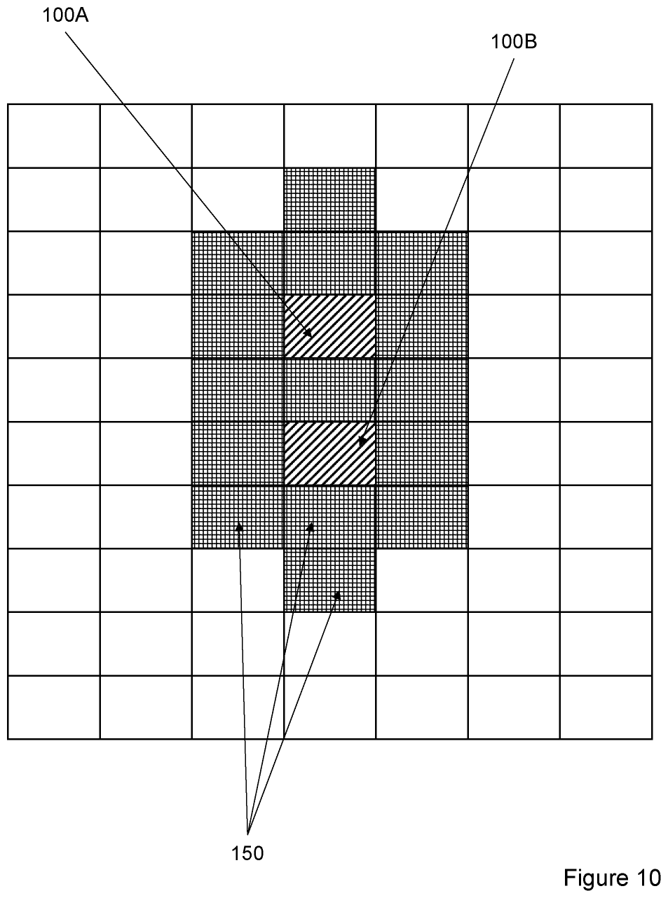

FIG. 10 shows a schematic depiction of an overhead view of the storage system of FIG. 1 which comprises a plurality of picking stations according to the present invention. In this example, the storage system comprises first and second picking stations 100A, 100B, and a plurality of picking locations. The first and second picking stations are arranged such that there are three shared picking locations, six picking locations which are only addressable by the first picking station and six picking locations which are only addressable by the second picking station. This allows storage containers for high demand products to be deposited in a picking location such that the product can be accessed by both the first picking station and the second picking station. As discussed above with reference to FIG. 10, it is advantageous for delivery containers to be placed in picking locations such that they are adjacent to one or more storage containers.

It should be understood that the arrangement of picking stations shown in FIG. 10 could be adapted to comprise three or more picking stations. The picking stations may be arranged such that they have picking locations in common, as is shown in FIG. 10, or there may be a greater degree of separation between the picking stations. A storage system may comprise one or more single picking stations (as is shown in FIG. 9) and/or one or more multiple picking stations (as is shown in FIG. 10).

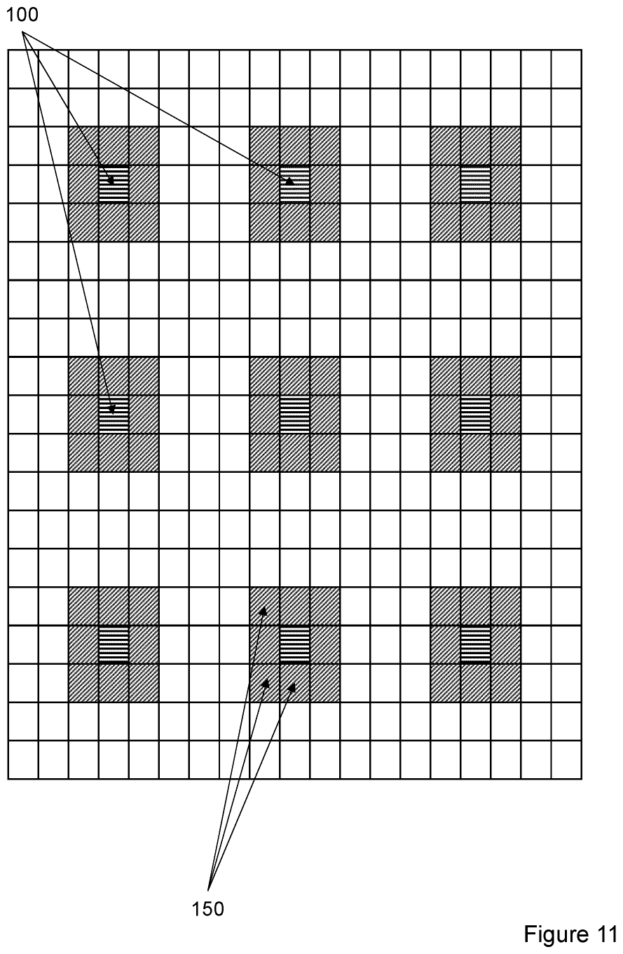

FIG. 11 shows a schematic depiction of an overhead view of a storage system as shown in FIG. 1 which comprises a plurality of picking stations according to a further example of the present invention. In this further example, each of the picking station 100 is surrounded by eight picking locations 150, such that the picking station and the associated picking locations from a 3×3 block of grid locations. In other respects, the operation of the picking station and its interaction with the plurality of bots is as described above.

It has been found that although the picking capacity of each individual picking station is decreased slightly when compared with the picking station discussed above with reference to FIG. 9, as only 8 picking locations are used rather than 10, the overall system performance is increased as it is possible to fit more of the 8 cell picking stations onto the surface of the grid. In particular, it has been found that it is possible to increase the density of picking stations by 33% by using 8 cell picking stations rather than 10 cell picking stations. A further advantage of the 8 cell picking station is that it is possible to achieve a higher proportion of short moves, that is picking movements that are made when a storage container is located adjacent to a delivery container. It has been found that separating each picking station from the next picking station by 3 grid cells in both the X and the Y direction provides an optimal balance. If the picking stations are closer together then it is less efficient to transport containers to and from the picking stations as the grid becomes congested, resulting in decreased system performance. If the picking stations are further apart then the reduction in the number of picking stations has a significant impact on system performance.

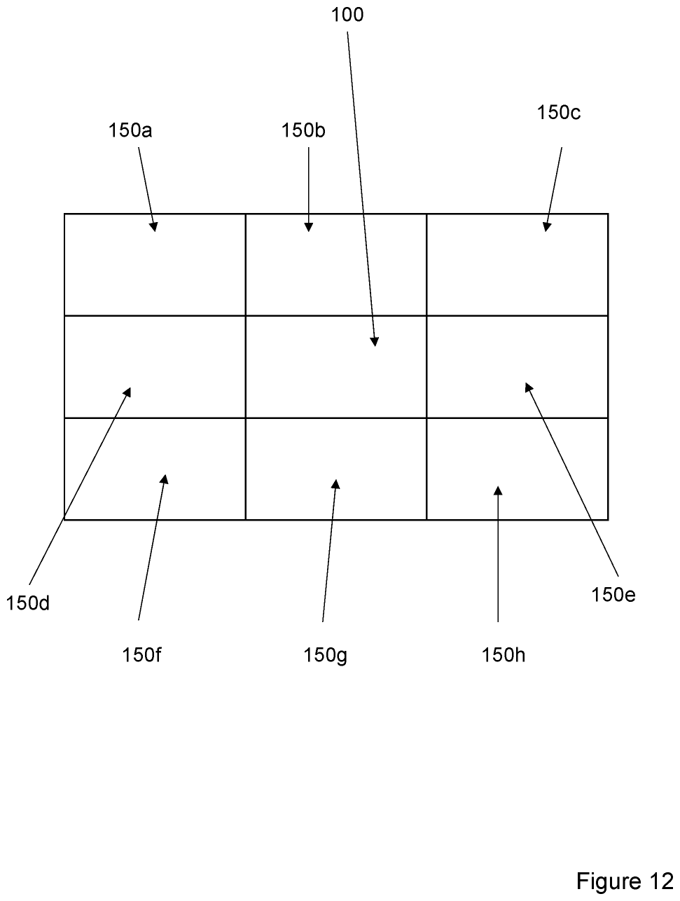

FIG. 12 shows a schematic depiction of a picking station according to a further example of the present invention, in which the robotic picking station 100 is surrounded by eight picking locations 150a-150h. In this example, picking locations 150d and 150e are reserved for use with delivery containers whilst picking locations 150a-150c and 150f-150h are reserved for use by storage containers. The picking locations may be allocated into one of two zones. For example, picking locations 150a, 150b, 150d & 150f are associated with a first zone of the picking station and picking locations 150c, 150e, 150g & 150h are associated with a second zone of the picking station. The robotic picking station may be performing picking operations within one of the zones whilst containers are being replaced within the other zone of the picking station.

For example, consider that a delivery container is present in picking location 150d and that each of the storage containers present in picking locations 150a, 150b & 150f contain a product (or products) which are to be picked as a part of a customer order. Appropriate commands can be sent to the robotic picking arm so as to pick the appropriate number of product items from each of the storage containers present in picking locations 150a, 150b & 150f, with the product items being transferred to the delivery container present in picking location 150d.

At substantially the same time that these picking operations are being executed then one or more bots are instructed to remove the storage containers present in picking locations 150c, 150g & 150h such that further storage containers may be deposited into picking locations 150c, 150g & 150h, the further storage containers containing a product (or products) which are to be picked as a part of a customer order. To maintain the efficiency of the picking process, three bots may be used to remove the storage containers present in picking locations 150c, 150g & 150h and a further three bots may be used may be used to deliver the further storage containers to picking locations 150c, 150g & 150h. If the delivery container present in picking location 150e is full then this may also be removed by a bot and replaced with a further delivery container, for example using a further bot.

Thus, the picking process is carried out in the first zone of the picking station whilst the replenishment process is carried out in the second zone of the picking station. Once both these processes are complete them the robotic arm may be rotated such that it is able to perform the picking process in the second zone of the picking station, that is picking one or more items from storage containers present in picking locations 150c, 150g & 150h into the delivery container present in picking location 150e. At the same time, one or more bots may be activated to perform the replenishment process in the first zone of the picking station, that is removing the storage containers present in picking locations 150a, 150b & 150d and then replacing them with further storage containers (and replacing the delivery container present in picking location 150d if required). It can be seen that these processes can be completed iteratively such that one zone of the picking station is used for picking whilst the other zone of the picking station is being replenished.

The picking process described above with reference to FIGS. 8 to 12 may be adapted for use in a stock consolidation process. If a single product is present in small numbers within two or more storage containers, then the plurality of storage containers may be transported by a bot to a robotic picking station 100. The picking station may then transfer the product into a single storage container, such that one or more storage containers are emptied. The empty container(s) can then be routed to a decant facility such that new product can be placed into them.

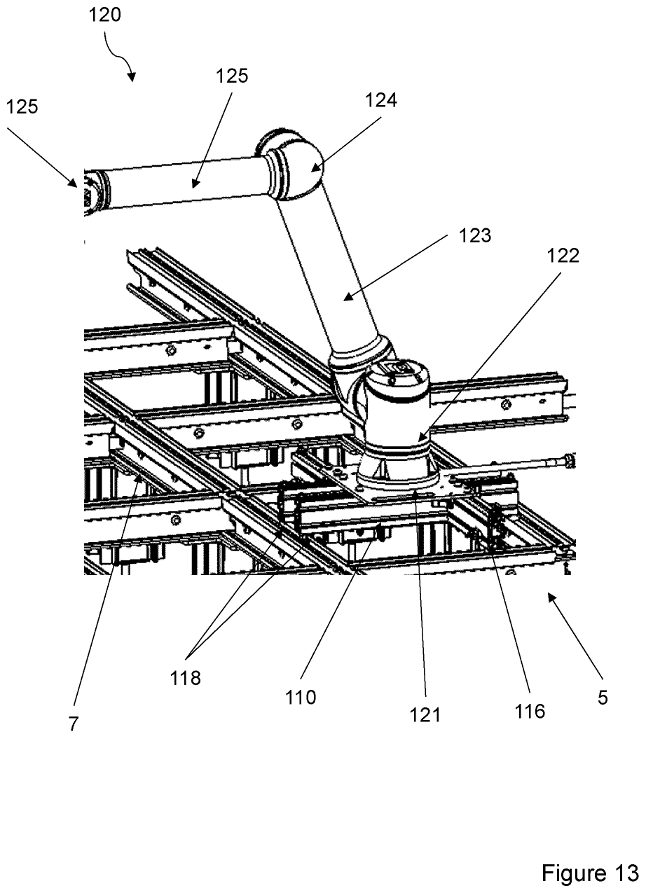

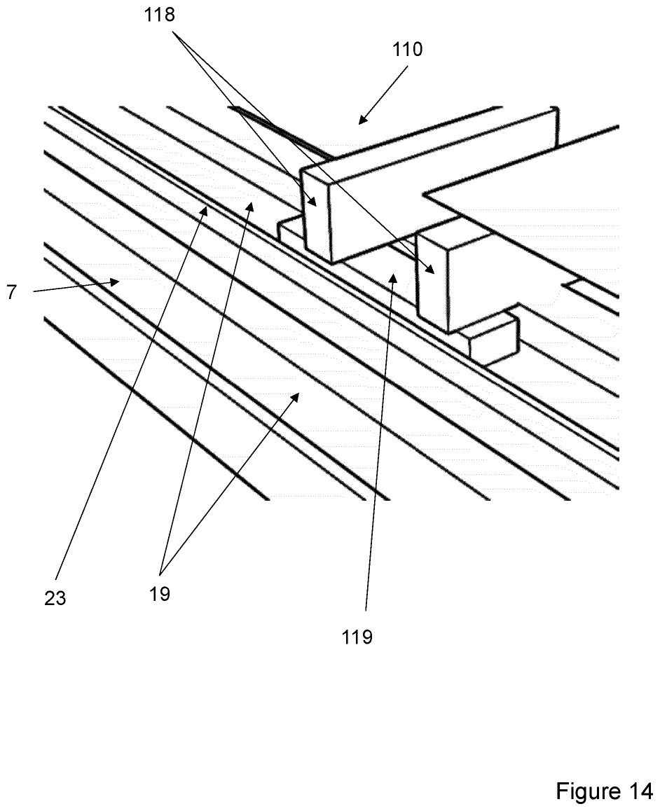

FIG. 13 shows a schematic depiction of a robotic arm 120 similar to that described above with reference to FIGS. 6 & 7, which comprises a base 121, first joint 122, upper arm portion 123, second joint 124, lower arm portion 125, third joint 126 and end effector (not shown). The robotic arm is secured to the horizontal members of the grid 5, 7 with base members 116, 118 which are secured to opposite sides of the grid cell in which the robotic arm is received. The members are arranged such that they allow bots to move along the tracks of the grid cells adjacent to the robotic picking station. FIG. 14 shows a schematic depiction of the connection of the robotic arm 120 to a horizontal member 7 of the grid structure. It can be seen that base members 118 can be clamped to the horizontal member 7 with a resilient member 119 being received within the track 19 nearest to the grid cell so as to reduce vibration passing from the grid structure into the robotic camera. The resilient members can also enable the picking arm to be centred within the grid cell such that it is correctly positioned. It can be seen that the other track 19 in the horizontal member 7 is clear such that a bot can access the grid cell adjacent to the picking station.

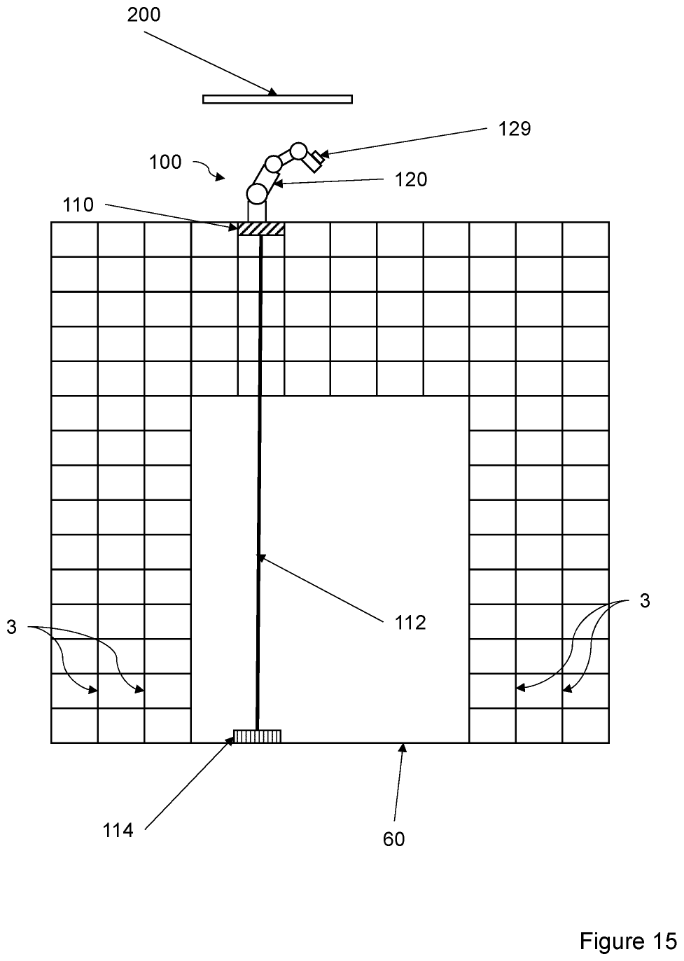

FIG. 15 shows a schematic depiction of a part of a storage system similar to that described above with reference to FIG. 7. FIG. 15 shows a floor 60 beneath the storage system. FIG. 15 also shows that the picking station further comprises a support member 112 which extends beneath the surface of the grid and down to the floor 60, where a support attachment 114 connects the support member 112 to the floor. The floor 60 may be a mezzanine level within the warehouse or it may be the ground floor to which the storage and retrieval system is attached. The attachment of the support member to the floor may reduce the vibration which passes from the grid to the robotic picking arm.

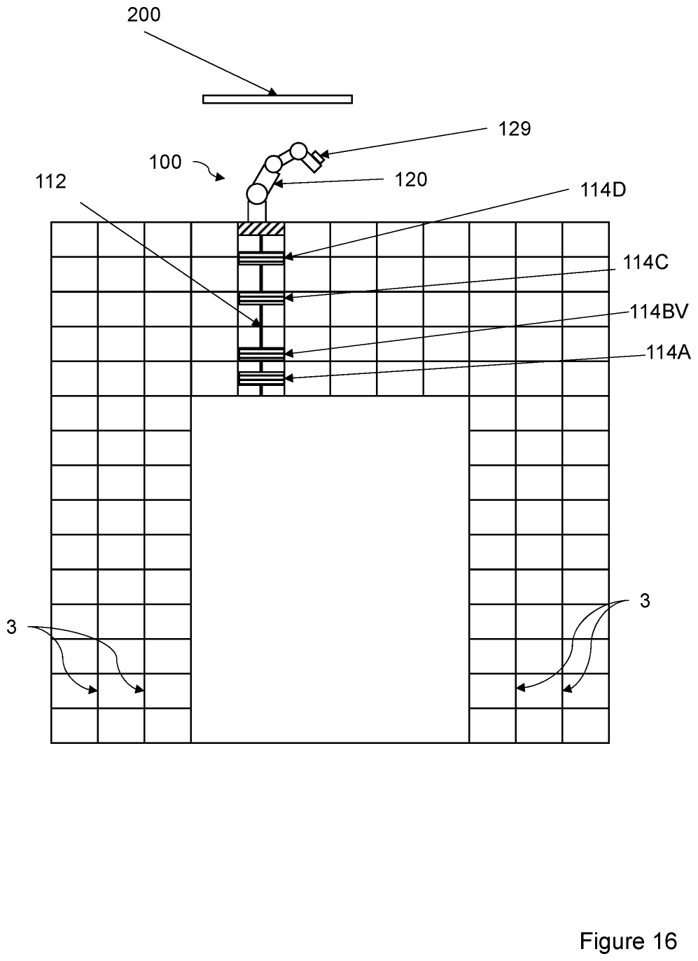

FIG. 16 shows a schematic depiction of a part of a storage system similar to that described above with reference to FIG. 15. FIG. 16 shows that the support member 112 extends beneath the surface of the grid and that one or more support attachments 114 may be provided to attach the support member to one or more of the upright members 3 and/or one or more of the horizontal members 5, 7 of the grid structure. The attachment of the camera array support in this manner may reduce the vibration of the camera array. For example, a support attachment 114A may be coupled to one or more of the upright members of a grid cell. In a further example, a support attachment 114B may be connected on top of one or more of the horizontal members 5, 7 of a grid cell. The support attachment 114B may be further connected to one or more of the upright members of that grid cell. In an alternative, a support attachment 114C may be connected to the underside of one or more of the horizontal members 5, 7 of a grid cell. The support attachment 114C may be further connected to one or more of the upright members of that grid cell. In a yet further example, a support attachment 114D may be connected to both the top and the underside of the one or more of the horizontal members 5, 7 of a grid cell. The support attachment 114D may be further connected to one or more of the upright members of the vertically adjoining grid cells. It should be understood that it is preferred that the support attachments do not extend into the space of horizontally adjacent grid cells as this could interfere with the storage and retrieval of containers. It should be understood that it is possible to combine the arrangements described above with respect to FIGS. 15 & 16, such that a support member 112 may be connected to a floor 60 and that the upper part of the support member may be connected to one or more of the upright members 3 and/or one or more of the horizontal members 5, 7 of the grid structure using one or more support attachments 114. The use of the support attachments 114 to secure the camera array support may reduce the vibration of the camera array.

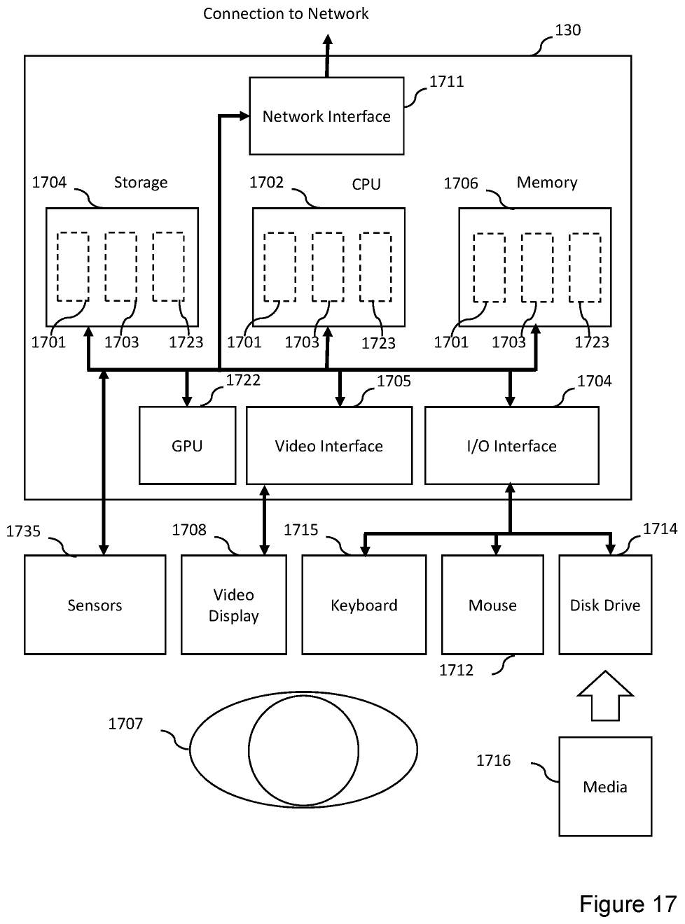

A suitably configured computer device 130, and associated communications networks, devices, software and firmware may provide a platform for enabling one or more embodiments as described above. By way of example, FIG. 17 shows a schematic depiction of a computer device 130 that may include a central processing unit (“CPU”) 1702 connected to a storage unit 1714 and to a random access memory 1706. The CPU 1702 may process an operating system 1701, application program 1703, and data 1723. The operating system 1701, application program 1703, and data 1723 may be stored in storage unit 1714 and loaded into memory 1706, as may be required. Computer device 130 may further include a graphics processing unit (GPU) 1722 which is operatively connected to CPU 1702 and to memory 1706 to offload intensive image processing calculations from CPU 1702 and run these calculations in parallel with CPU 1702. An operator 1707 may interact with the computer device 130 using a video display 1708 connected by a video interface 1705, and various input/output devices such as a keyboard 1715, mouse 1712, and disk drive or solid state drive 1714 connected by an I/O interface 1704. In known manner, the mouse 1712 may be configured to control movement of a cursor in the video display 1708, and to operate various graphical user interface (GUI) controls appearing in the video display 1708 with a mouse button. The disk drive or solid state drive 1714 may be configured to accept computer readable media 1716. The computer device 130 may form part of a network via a network interface 1711, allowing the computer device 130 to communicate with other suitably configured data processing systems (not shown). One or more different types of sensors 1735 may be used to receive input from various sources.

The present system and method may be practiced on virtually any manner of computer device including a desktop computer, laptop computer, tablet computer or wireless handheld. The present system and method may also be implemented as a computer-readable/useable medium that includes computer program code to enable one or more computer devices to implement each of the various process steps in a method in accordance with the present invention. In case of more than computer devices performing the entire operation, the computer devices are networked to distribute the various steps of the operation. It is understood that the terms computer-readable medium or computer useable medium comprises one or more of any type of physical embodiment of the program code. In particular, the computer-readable/useable medium can comprise program code embodied on one or more portable storage articles of manufacture (e.g. an optical disc, a magnetic disk, a tape, etc.), on one or more data storage portioned of a computing device, such as memory associated with a computer and/or a storage system.

In further aspects, the disclosure provides systems, devices, methods, and computer programming products, including non-transient machine-readable instruction sets, for use in implementing such methods and enabling the functionality described previously.

In this document, the language “movement in the n-direction” (and related wording), where n is one of x, y and z, is intended to mean movement substantially along or parallel to the n-axis, in either direction (i.e. towards the positive end of the n-axis or towards the negative end of the n-axis). In this document, the word “connect” and its derivatives are intended to include the possibilities of direct and indirection connection. For example, “x is connected to y” is intended to include the possibility that x is directly connected to y, with no intervening components, and the possibility that x is indirectly connected to y, with one or more intervening components. Where a direct connection is intended, the words “directly connected”, “direct connection” or similar will be used. Similarly, the word “support” and its derivatives are intended to include the possibilities of direct and indirect contact. For example, “x supports y” is intended to include the possibility that x directly supports and directly contacts y, with no intervening components, and the possibility that x indirectly supports y, with one or more intervening components contacting x and/or y. The word “mount” and its derivatives are intended to include the possibility of direct and indirect mounting. For example, “x is mounted on y” is intended to include the possibility that x is directly mounted on y, with no intervening components, and the possibility that x is indirectly mounted on y, with one or more intervening components. In this document, the word “comprise” and its derivatives are intended to have an inclusive rather than an exclusive meaning. For example, “x comprises y” is intended to include the possibilities that x includes one and only one y, multiple y's, or one or more y's and one or more other elements. Where an exclusive meaning is intended, the language “x is composed of y” will be used, meaning that x includes only y and nothing else. In this document, “controller” is intended to include any hardware which is suitable for controlling (e.g. providing instructions to) one or more other components. For example, a processor equipped with one or more memories and appropriate software to process data relating to a component or components and send appropriate instructions to the component(s) to enable the component(s) to perform its/their intended function(s).

In one respect, the present invention concerns a robotic picking station is provided for use with a cubic automated storage and retrieval system. The picking station is configured to operate on the grid of the storage and retrieval system such that is received within a single grid cell of the storage and retrieval system. The picking station is mounted to the framework of the storage and retrieval system and comprises one or more robotic arms. The picking station comprises a support means which extends below the grid of the storage system and is secured beneath the grid. The support means may be connected to a floor of the storage system. The support means may be connected to one or more framework elements.

1.-32. (canceled)

33. A picking station for use in a grid-based storage system, the picking station comprising:
a robotic arm; and
a mount for mounting the robotic arm to one or more framework members of the storage system, the robotic arm being configured to be received within a single grid cell of the storage system; wherein the picking station is configured to access:
i) eight grid cells surrounding the picking station reserved for use by the picking station; and
ii) the eight grid cells are divided into a first zone and a second zone such that each of the zones include one or more grid cells for receiving a delivery container and one or more grid cells for receiving a respective storage container.

34. A picking station according to claim 33, wherein the mount comprises:
a support member which extends below a surface of a grid of the storage system.

35. A picking station according to claim 34, wherein the support member is connected to one or more framework members of the storage system.

36. A picking station according to claim 34, wherein the support member is connected to one or more vertical members of the storage system.

37. A picking station according to claim 34, wherein the support member is connected to one or more horizontal members of the storage system.

38. A picking station according to claim 34, wherein the support member is connected to a floor of the storage system.

39. A picking station according to claim 33, wherein the eight grid cells surrounding the picking station are divided into a first zone and a second zone such that each of the zones comprise:
one grid cell for receiving a delivery container and three grid cells for receiving a respective storage container.

40. A picking station according to claim 33, wherein the mount is directly connected to one or more vertical members of the storage system.

41. A picking station according to claim 33, wherein the mount is directly connected to one or more horizontal members of the storage system.

42. A picking station according to claim 33, wherein the mount comprises:
a plinth, the plinth being configured to be connected to one or more framework members of the storage system and to be received within a grid cell of the storage system.

43. A picking station according to claim 42, wherein the plinth extends across substantially all of the grid cell within which the picking station is received.

44. A picking station according to claim 33, wherein the picking station further comprises:
one or more cameras.

45. A picking station according to claim 44, comprising:
one or more cameras mounted above the picking station.

46. A picking station according to claim 44, comprising:
one or more cameras mounted on the robotic arm.

47. A picking station according claim 33, wherein the mount comprises:
one or more optical sensors.

48. A picking station according to claim 33, comprising:
one or more barcode scanners are mounted on the robotic arm.

49. A picking station according to claim 33, wherein the picking station comprises:
a computing device, the computing device including one or more processing units, one or more volatile data storage units, one or more non-volatile data storage units and a network interface.

50. A picking station according to claim 33, wherein the picking station is communicably coupled to a computing device, the computing device comprising:
one or more processing units, one or more volatile data storage units, one or more non-volatile data storage units and a network interface.

51. A picking station according to claim 49, wherein the computing device comprises:
a controller apparatus which is configured, in use, to send signals to the picking station to control operation of the robotic arm.

52. A picking station according to claim 33, wherein the robotic arm comprises:
one or more end effectors.

53. A picking station according to claim 33, wherein the robotic arm is configured to exchange a first end effector for a second effector.

54. A picking station according to claim 33, wherein the robotic arm is configured, in use, to select an item from a container received in a first grid cell and to transfer the item to a container received in a second grid cell.

55. A picking station according to claim 33, wherein the picking station comprises:
a plurality of robotic arms.

56. A picking station according to claim 33, wherein the picking station is configured, in use, to be retracted below the surface of the storage system.

57. A storage system comprising:
a first set of tracks extending in a first direction;
a second set of tracks extending in a second direction transverse to the first direction, to form a grid containing a plurality of grid cells,
a framework structure on which the first set of tracks and the second set of tracks are received such that a stack of containers may be stored below each of the plurality of grid cells; and
one or more picking stations according to claim 33.

58. A storage system according to claim 57, wherein the storage system comprises:
a plurality of load-handling devices for lifting and moving containers stacked in stacks within the storage system, each of the load-handling devices being configured to move on the tracks above the stacks of containers.

59. A storage system according to claim 58, wherein the picking station is configured, in use, to pick one or more items from the storage containers received in the first zone and to transfer them into the delivery container of the first zone.

60. A storage system according to claim 59, wherein a plurality of load-handling devices are configured to remove one or more storage containers from the second zone.

61. A storage system according to claim 60, wherein a load-handling device is configured to remove the delivery container from the second zone.

62. A storage system according to claim 61, wherein a plurality of load-handling devices are configured to deposit one or more storage containers into grid locations in the second zone.

63. A storage system according to claim 62, wherein a load-handling device is configured to deposit a delivery container into the second zone.

64. A storage system according to claim 63, wherein the picking station is configured to pick one or more items from the storage containers received in the second zone and to transfer the picked items into the delivery container of the second zone.
